(19) United States
(12) Patent Application Publication
(10) Pub. No.: US 2004/0077763 A1
(43) Pub. Date: Apr. 22, 2004

(54) Flame retardant polycarbonate composition

(76) Inventors: James Y.J. Chung, Wexford, PA (US); Winfried Paul, Coraopolis, PA (US)

Correspondence Address: BAYER POLYMERS LLC, 100 BAYER ROAD, PITTSBURGH, PA, 15205, US

(21) Appl. No.: 10/274,906

(22) Filed: Oct. 21, 2002

(51) Int. Cl. C08K 3/34

(52) U.S. Cl. 524/442; 524/451

(57) ABSTRACT

A flame-retardant thermoplastic molding composition is disclosed. The composition contains polycarbonate resin, about 0.1-1.5 percent by weight of an inorganic metal complex and an amount of a carboxylic acid sufficient to neutralize the hydrotalcite. The composition is characterized by its improved thermal stability.

### FIELD OF THE INVENTION

The invention concerns thermoplastic molding compositions and more particularly, flame-retardant polycarbonate compositions.

### SUMMARY OF THE INVENTION

A flame-retardant thermoplastic molding composition is disclosed. The composition contains polycarbonate resin, about 0.1-1.5 percent by weight of an inorganic metal complex and carboxylic acid. The inventive composition is characterized by its improved thermal stability.

### BACKGROUND OF THE INVENTION

Polycarbonate resins are well known and have long been used for a variety of applications because of their characteristic combination of good mechanical and physical properties. Flame retardant thermoplastic molding compositions containing polycarbonate resins are likewise known yet the flame retardance is often attained at the sacrifice of other properties. The search has been continuing for polycarbonate compositions that exhibit goof flame retardance with minimal loss of other properties. Hydrotalcite is a known natural mineral, which is produced, in relatively small amounts in limited areas. It is also known to produce synthetic hydrotalcites by the reaction of a carbonate source, a magnesium source, and an aluminum source. U.S. Pat. Nos. 3,539,306; 3,650,704 and 4,351,814 disclose the preparation of synthetic hydrotalcites. U.S. Pat. No. 6,291,570 disclosed a flame retardant resin composition that contains hydrotalcite compound particles. Accordingly disclosed was a substantially halogen-free flame retardant synthetic resin composition that contains a synthetic resin and hydrotalcite compound particles in an amount of more than 10 wt % and 80 wt % or less based on the total weight of the components. U.S. Pat. No. 4,729,854 disclosed a fire-retardant composition that contains a thermoplastic or a thermosetting resin, a halogen-containing organic fire retardant, and an additive amount a hydrotalcite defined in terms of its specific surface area, said to be a stabilizer. U.S. Pat. No. 4,154,718 disclosed A fire-retardant thermoplastic resin composition consisting essentially of: (A) a thermoplastic synthetic resin, (B) about 40 to 150 parts by weight of the thermoplastic synthetic resin of a magnesium-containing inorganic compound selected from the group consisting of magnesium hydroxide, basic magnesium carbonate hydrate and hydrotalcites, and (C) a fire-retardant assistant selected from a specified group of specified compounds. A presently pending patent application, (U.S. Ser. No. 09/990,128; filed Nov. 21, 2001) assigned to the present assignee disclosed a composition that contains polycarbonate and hydrotalcite.

### DETAILED DESCRIPTION OF THE INVENTION

The inorganic metal complex suitable in the context of the present invention is a mineral, including natural and synthetic varieties, having a layered structure of Aluminum oxide and Magnesium oxide. A preferred such inorganic metal complex is hydrotalcite. A typical hydrotalcite may be represented by the formula Mg₄Al₂(OH)₁₂CO₃3H₂O or, in the alternative as Mg₆Al₂(CO₃)(OH)₆.4(H₂O) Other suitable hydrotalcite minerals refer to modifications of these formulas such as calcined versions in the form of aluminum magnesium oxide and such as are made by changing the Al to Mg ratio and by including other metal compounds such as zinc oxide. Preferably the Mg is not substituted.

The preferred inorganic metal complex is hydrotalcite that is represented as Mg₄₋₅Al₂ (OH)₁₃ CO₃. It is commercially available as Kyowa DHT-4C from Mitsui USA.

The amount of inorganic metal complex in the inventive composition is 0.1 to 1.5, preferably 0.1 to 1.2 percent relative to the weight of the composition.

In a preferred embodiment of the invention the composition contains no additional flame retarding agents such as phosphorous compounds and/or halogenated compounds that are known for their flame retardant utility in polycarbonate compositions.

The preferred inorganic metal complex has an average particle diameter of 2 microns, preferably 0.4 to 1.0 microns. Further, the inorganic metal complex is preferably characterized in that its specific surface area, measured by the BET method is 1 to 30, more preferably 3 to 20, most preferably 3 to 12 m²/g.

The method and conditions for producing hydrotalcite suitable in the present invention are known see for instance U.S. Pat. Nos. 3,650,704 and 3,879,525 incorporated by reference herein.

The carboxylic acid suitable in the present context includes both aliphatic and aromatic acids. Fatty acids, both saturated and unsaturated are included within the suitable acids. Preferably, the carboxylic acid is aliphatic and most preferably it contains 2-6 carbon atoms. Citric acid is an advantageously used.

The acid is used in the practice of the invention in an amount sufficient to neutralize the included inorganic metal complex.

Suitable polycarbonate resins for preparing the copolymer of the present invention are homopolycarbonates and copolycarbonates and mixtures thereof.

The polycarbonates generally have a weight average molecular weight of 10,000 to 200,000, preferably 20,000 to 80,000 and their melt flow rate, per ASTM D-1238 at 300° C., is about 1 to about 65 g/10 min., preferably about 2 to 24 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formulae (1) or (2).

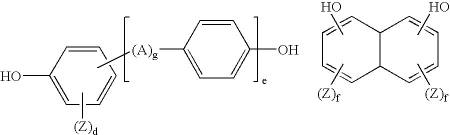

wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

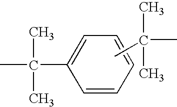

e and g both denote the number 0 to 1;

Z denotes F, Cl, Br or C₁-C₄-alkyl and if several Z radicals are substituents in one aryl radical, they may be identical or different from one another;

d denotes an integer from 0 to 4; and

f denotes an integer from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxyphenyl)sulfoxides, bis-(hydroxyphenyl)-sulfides, bis-(hydroxyphenyl)-sulfones, dihydroxydiphenyl cycloalkanes, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,227,458, 5,105,004; 5,126,428; 5,109,076; 5,104,723; 5,086,157; 3,028,356; 2,999,835; 3,148,172; 2,991,273; 3,271,367; and 2,999,846, all incorporated herein by reference.

Further examples of suitable bisphenols are 2,2-bis-(4-hydroxyphenyl)-propane (bisphenol A), 2,4-bis-(4-hydroxyphenyl)-2-methylbutane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxybenzophenone, 2,4-bis-(3,5-dimethyl-4-hydroxyphenyl)-cyclohexane, α,α′-bis-(3,5-dimethyl-4-hydroxyphenyl)-p-diisopropylbenzene and 4,4′-sulfonyl diphenol.

Examples of particularly preferred aromatic bisphenols are 2,2,-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention is phenolphthalein-based polycarbonate, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05 to 2.0 mol % (relative to the bisphenols) of polyhydroxy compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxy compounds which may be used for this purpose: phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methylphenol; 2,4-dihydroxybenzoic acid; 2-(4-hydroxyphenyl)-2-(2,4-dihydroxyphenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference, U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention such as disclosed in U.S. Pat. No. 3,912,688, incorporated herein by reference, may be used.

Suitable polycarbonate resins are available in commerce, for instance, Makrolon FCR, Makrolon 2600, Makrolon 2800 and Makrolon 3100, all of which are bisphenol based homopolycarbonate resins differing in terms of their respective molecular weights and characterized in that their melt flow indices (MFR) per ASTM D-1238 are about 16.5 to 24, 13 to 16, 7.5 to 13.0 and 3.5 to 6.5 g/10 min., respectively. These are products of Bayer Corporation of Pittsburgh, Pa.

A polycarbonate resin suitable in the practice of the invention is known and its structure and methods of preparation have been disclosed, for example, in U.S. Pat. Nos. 3,030,331; 3,169,121; 3,395,119; 3,729,447; 4,255,556; 4,260,731; 4,369,303 and 4,714,746 all of which are incorporated by reference herein.

The invention is further illustrated but is not intended to be limited by the following examples in which all parts and percentages are by weight unless otherwise specified.

### EXAMPLES

Compositions in accordance with the present invention were prepared and their properties evaluated. The polycarbonate that was used in these compositions was Makrolon 2608 polycarbonate resin (a bisphenol-A based homopolycarbonate having a melt flow rate of about 11 g/10 min. per ASTM D 1238) a product of Bayer Corporation. The inorganic metal complex designated in the table as “type 1” is hydrotalcite obtained commercially from Mitsui USA, having the commercial designation Kyowa DHT-4C. The inorganic metal complex that is designated in the table as “type 2” is an aluminum magnesium oxide similarly obtained commercially as Kyowa KW 2200. The citric acid that was used in the course of the experiments was chemically pure grade.

The preparation of these compositions and their testing were conventional; the properties are tabulated below:

| Example | 1 | 2 | 3 | 4 | 5 | 6 | 7 |
|---|---|---|---|---|---|---|---|
| Polycarbonate | 99.9 | 99.9 | 99.9 | 99.8 | 99.8 | 99.7 | 99.7 |
| Hydrotalcite-type 1 | 0.1 | 0.0 | 0.0 | 0.1 | 0.0 | 0.2 | 0.0 |
| Hydrotalcite-type 2 | 0.0 | 0.1 | 0.0 | 0.0 | 0.1 | 0.0 | 0.2 |
| Citric acid | 0.0 | 0.0 | 0.1 | 0.1 | 0.1 | 0.1 | 0.1 |
| MER gm/10 min. | 17.5 | 18.2 | 12.2 | 11.8 | 11.8 | 12.1 | 12.4 |
| MFR (Regrinds), | 27.8 | 26.3 | 16.8 | 12.8 | 12.3 | 13.7 | 14.5 |
| gm/10 min. | | | | | | | |
| Notched Izod Impact | 15.5 | 15.8 | 16.5 | 14.5 | 14 | 6.1 | 11.5 |
| (⅛″) | | | | | | | |
| UL94 (⅛″) | V-2 | V-2 | V-2 | V-2 | V-2 | V-2 | V-2 |

The melt flow rate (MFR)—determined in accordance with ASTM D 1238—show that the added acid stabilizes the composition. In comparative compositions that contained no citric acid—Examples 1 and 2—the MFR values of virgin pellets are higher than those of virgin pellets in invention, Examples 4, 5, 6 and 7. Furthermore, the comparative MFR values of the reground compositions, compositions that were subjected to molding were much higher than the values of virgin pellets. The addition of citric acid minimizes the aforementioned differences, indicating greater thermal stability for the inventive compositions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is

1. A flame retardant thermoplastic molding composition comprising polycarbonate resin, an inorganic metal complex in an amount of 0.1 to 1.5 percent relative to the weight of the composition and an amount of a carboxylic acid sufficient to neutralize the inorganic metal complex.

2. The thermoplastic molding composition of claim 1 wherein the amount of the inorganic metal complex is 0.1 to 1.2 percent.

3. The flame retardant thermoplastic molding composition of claim 1 wherein the inorganic metal complex is hydrotalcite.

4. The flame retardant thermoplastic molding composition of claim 3 wherein the hydrotalcite is represented by the formula Mg₄Al₂(OH )₁₂CO₃3H₂O.

5. The flame retardant thermoplastic molding composition of claim 3 wherein the hydrotalcite is represented by the formula Mg₄₋₅Al₂(OH)₁₃CO₃.

6. The flame retardant thermoplastic molding composition of claim 3 wherein the hydrotalcite is represented by the formula Mg₆Al₂(CO₃)(OH)₆.4(H₂O).

7. The flame retardant thermoplastic molding composition of claim 1 characterized in the absence therefrom of flame retarding agents selected from the group of phosphorous compounds and halogenated compounds.

8. The flame retardant thermoplastic molding composition of claim 1 wherein the inorganic metal complex has an average particle diameter of 2 microns.

9. The flame retardant thermoplastic molding composition of claim 1 wherein the inorganic metal complex has an average particle diameter of 0.4 to 1.0 microns.

10. The flame retardant thermoplastic molding composition of claim 1 wherein the carboxylic acid is aliphatic.

11. The flame retardant thermoplastic molding composition of claim 1 wherein the carboxylic acid is citric acid.

12. The flame retardant thermoplastic molding composition of claim 3 wherein the weight ratio between the hydrotalcite and the carboxylic is in the range of 0.5 to 1.5.

13. The flame retardant thermoplastic molding composition of claim 1 wherein the inorganic metal complex is aluminum magnesium oxide.
